(19) United States
(12) Patent Application Publication
(10) Pub. No.: US 2011/0123127 A1
(43) Pub. Date: May 26, 2011

(54) IMAGE PROCESSING APPARATUS, CONTROL METHOD FOR THE SAME, PROGRAM

(75) Inventors: Tsuyoshi Mima, Yokohama-shi (JP); Masanori Ichikawa, Yamato-shi (JP)

(73) Assignee: CANON KABUSHIKI KAISHA, Tokyo (JP)

(21) Appl. No.: 12/911,819

(22) Filed: Oct. 26, 2010

(30) Foreign Application Priority Data
Nov. 20, 2009 (JP) 2009-265531

(51) Int. Cl. G06K 9/36

(52) U.S. Cl. 382/239

(57) ABSTRACT

Provided is an image processing apparatus that reduces the processing time taken to encode image data that has been divided into blocks, as well as suppresses a reduction in image quality. To accomplish this, among block images obtained by dividing the image into blocks, the image processing apparatus executes encoding processing using a first method with priority on important block images such as those including thin lines or characters. Furthermore, the image processing apparatus executes encoding processing using a second method if the encoded data amount of blocks that have been encoded becomes greater than or equal to a predetermined threshold.

### BACKGROUND OF THE INVENTION

1. Field of the Invention

The present invention relates to an image processing apparatus, a control method for the same, and a program that are for compressing and encoding image data.

2. Description of the Related Art

Since storing high resolution image data in a memory requires a very large amount of memory to be used, it is effective to compress the image data before storing it in the memory. In image compression, compressed image data is ultimately decompressed and output, and therefore encoding is desirably performed using a variable length lossless method to prevent a loss in image quality. However, depending on the image, the lossless variable length method requires a very large amount of interpolation information in order to perform image compression. It is therefore necessary to compress the image data at a high compression rate or perform control such that the total encoded data amount falls within the memory capacity by switching the encoding method depending on the image.

Japanese Patent Laid-Open No. 11-252563 proposes technology for dividing an input image into blocks, calculating an image characteristic for each block, and determining an image type. Specifically, a variable length encoding method and a fixed length encoding method are selectively switched based on the result of the determination regarding the calculated image characteristics. Accordingly, even images that have very different image characteristics, such as computer graphic (CG) images and natural images, can be encoded efficiently, and even if the memory capacity for encoded data is low, it is possible to provide high quality decompressed images in which image degradation has been suppressed to a minimum.

However, with the variable length encoding method in the above-described conventional technology, the total encoded data amount cannot be known without actually performing encoding processing. Accordingly, depending on the image, the total encoded data amount may exceed the available memory capacity, and therefore it is necessary to first perform provisional encoding processing without storing the resulting data to memory, and then raise the compression rate and perform encoding processing again if the encoded data amount exceeds the memory capacity. This processing is repeated until the memory capacity is not exceeded, and therefore is very time-consuming.

In view of this, in the technology disclosed in Japanese Patent Laid-Open No. 11-252563, once a specific threshold is exceeded, the encoding method is switched to a fixed length encoding method that enables predicting the encoded data amount in order to prevent the target size to be used from being exceeded, thus enabling image compression to be completed with encoding processing being performed only one time. However, if the blocks into which the image data has been divided are compressed in order, image quality will degrade and an unclear image will be obtained if, for example, a large number of thin lines or characters are included in the image blocks toward the end.

### SUMMARY OF THE INVENTION

The present invention enables realization of an image processing apparatus, a control method for the same, and a program that reduce the processing time taken to encode image data that has been divided into blocks, as well as suppresses a reduction in image quality.

One aspect of the present invention provides an image processing apparatus comprising: an input unit that receives an input of image data; an attribute information generation unit that generates attribute information for each predetermined block unit of the input image data; a priority order setting unit that, based on the generated attribute information, sets a priority order for encoding in the block units; an encoded data amount calculation unit that, in encoding of the blocks in order based on the set priority order, calculates a total encoded data amount of blocks that have been encoded; a first encoding unit that, in a case where the total encoded data amount is less than a predetermined threshold, encodes image data of a block with use of a first method; and a second encoding unit that, in a case where the total encoded data amount is greater than or equal to the predetermined threshold, encodes image data of the block with use of a second method that results in a lower encoded data amount than the first method.

Another aspect of the present invention provides a control method for an image processing apparatus, comprising: receiving, by an input unit, an input of image data; generating, by an attribute information generation unit, attribute information for each predetermined block unit of the input image data; setting, by a priority order setting unit, a priority order for encoding in the block units, based on the generated attribute information; in encoding of the blocks in order based on the set priority order, calculating, by an encoded data amount calculation unit, a total encoded data amount of blocks that have been encoded; in a case where the total encoded data amount is less than a predetermined threshold, encoding, by a first encoding unit, image data of a block with use of a first method; and in a case where the total encoded data amount is greater than or equal to the predetermined threshold, encoding, by a second encoding unit, image data of the block with use of a second method that results in a lower encoded data amount than the first method.

Further features of the present invention will be apparent from the following description of exemplary embodiments with reference to the attached drawings.

### BRIEF DESCRIPTION OF THE DRAWINGS

FIG. 1 is a block diagram showing an example of a configuration of an MFP 100 according to Embodiment 1.

FIG. 2 is a block diagram showing an example of a configuration of an image encoding processing unit 110 according to Embodiment 1.

FIG. 3 is a diagram illustrating encoding processing performed in accordance with a priority order according to Embodiment 1.

FIG. 4 is a flowchart showing a processing procedure of encoding processing performed in accordance with a priority order according to Embodiment 1.

FIG. 5 is a diagram illustrating a method for determining image attribute information according to Embodiment 1.

FIG. 6 is a diagram schematically showing an edge counting method according to Embodiment 1.

FIG. 7 is a diagram schematically showing a method for setting a priority order and an output sequence according to Embodiment 1.

FIG. 8 is a diagram showing a structure of a packet generated by a packet generation unit 205 according to Embodiment 1.

FIG. 9 is a diagram showing an example of a configuration of the packet generation unit 205 according to Embodiment 1.

FIG. 10 is a diagram showing an example of a configuration of an image compression unit 206 according to Embodiment 1.

FIG. 11 is a diagram showing an example of a configuration of a first compression processing unit 2062 according to Embodiment 1.

FIG. 12 is a diagram showing an example of a configuration of a second compression processing unit 2063 according to Embodiment 1.

FIG. 13 is a diagram showing an example of a tile image according to Embodiment 2.

FIG. 14 is a diagram showing an example of a Q table ID list according to Embodiment 2.

FIG. 15 is a flowchart showing a processing procedure of encoding processing performed in accordance with a priority order according to Embodiment 2.

FIG. 16 is a block diagram showing an example of a configuration of an image encoding processing unit 1600 according to Embodiment 3.

FIGS. 17A and 17B are flowcharts showing a processing procedure of encoding processing according to Embodiment 3.

FIG. 18 is a diagram schematically showing a method for setting a solid image detection flag and an output sequence according to Embodiment 3.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### Embodiment 1

Configuration of Image Processing Apparatus

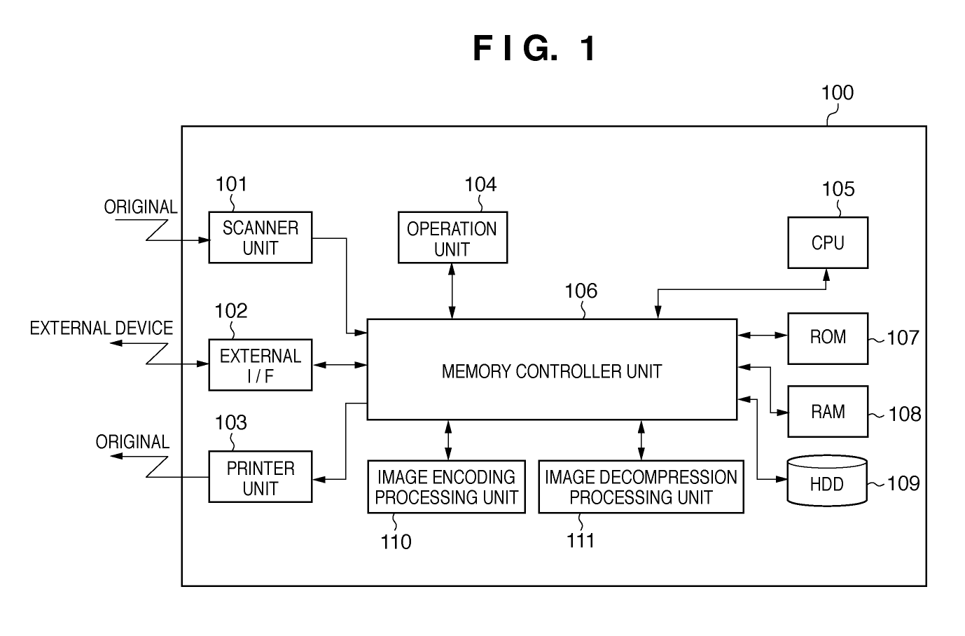

Below is a description of Embodiment 1 with reference to FIGS. 1 to 12. First, a description of the configuration of an image processing apparatus according to the present embodiment is given with reference to FIG. 1. The image processing apparatus according to the present embodiment is described taking the example of a multi-function peripheral (MFP). An MFP 100 is an image processing apparatus including a plurality of functions such as a copy function for printing job data that has been output from a scanner and stored in a memory, and a print function for printing job data that has been output from an external apparatus such as a computer and stored in a memory. The MFP 100 can be a full-color device or a monochrome device, and the basic configuration of a full-color device is often the same as that of a monochrome device, with the exception of color processing, internal data, and the like. The following description therefore focuses on a full-color device, and descriptions of a monochrome device have been added only when necessary. Also, the image processing apparatus of the present invention may be a single-function peripheral (SFP) that includes only the print function. Furthermore, the present invention can be realized as an image processing system that includes a plurality of image processing apparatuses such as MFPs and SFPs.

The MFP 100 includes a scanner unit 101, an external I/F 102, a printer unit 103, an operation unit 104, a CPU 105, a memory controller unit 106, a ROM 107, a RAM 108, an HDD 109, an image encoding processing unit 110, and an image decompression processing unit 111. The scanner unit 101 reads an image of a paper original or the like, and performs image processing on the read data. The external I/F 102 transmits and receives image data and the like to/from a fax device, a network-connected device, and an external dedicated apparatus. The printer unit 103 forms an image on a sheet such as a recording sheet in accordance with image data on which image processing has been performed. The operation unit 104 enables a user to select various processing flows and functions of the MFP 100 and give operation instructions. Along with the increase in the resolution of the display apparatus with which the operation unit 104 is provided, the operation unit 104 can also display a preview of image data in a document management unit and allow the user to confirm a print output image at the output destination.

The CPU 105 operates in accordance with a program read from the ROM 107. For example, the CPU 105 interprets page description language (PDL) code data received from a host computer via the external I/F 102, and expands the PDL code data into raster image data. The CPU 105 also executes color matching processing with use of color profiles of various types of image data. The image encoding processing unit 110 compresses image data and the like that is stored in the RAM 108 or the HDD 109, with use of various compression methods such as JBIG and JPEG. The image decompression processing unit 111 decompresses encoded data that is stored in the RAM 108 or the HDD 109.

The memory controller unit 106 controls access to the ROM 107, the RAM 108, and the HDD 109, which are storage apparatuses connected thereto. If there is competition between memory access performed by connected master devices, the memory controller unit 106 performs arbitration so that the master devices access slave memories selected in order based on a priority order. The ROM 107 is a read-only memory that has various programs such as a boot sequence and font information stored therein in advance. The RAM 108 is a readable and writable memory that stores various programs, setting information, and image data that has been sent from the scanner unit 101 or the external I/F 102 via the memory controller unit 106. The HDD 109 is a high-capacity storage apparatus that stores image data that has been compressed by the image encoding processing unit 110.

Configuration of Image Encoding Processing Unit

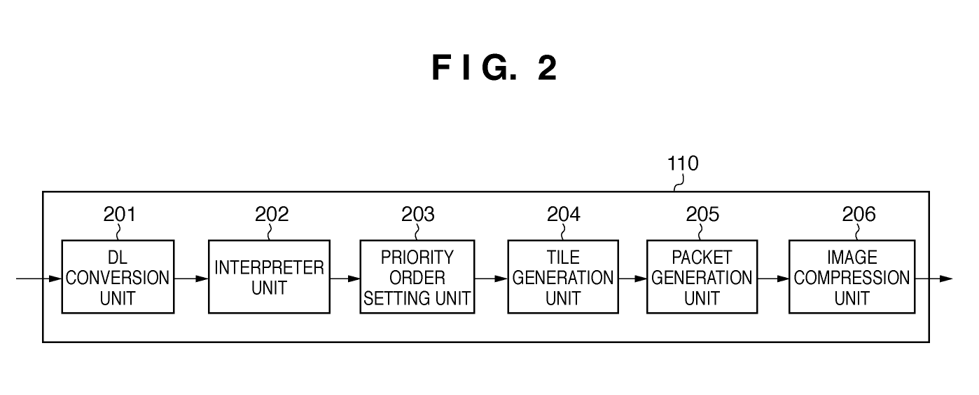

Next is a description of the configuration of the image encoding processing unit 110 according to this embodiment of the present invention with reference to FIG. 2. The following describes image encoding processing in the case of receiving image data from a host computer connected to the image processing apparatus via a network, and printing out the received image data. The image data (GDI commands or the like) from the host computer is once stored in an external dedicated apparatus that is for performing spool processing. The image data stored in the external dedicated apparatus is received via the external I/F 102, and input to the image encoding processing unit 110. As shown in FIG. 2, the image encoding processing unit 110 includes a DL conversion unit 201, an interpreter unit 202, a priority order setting unit 203, a tile generation unit 204, a packet generation unit 205, and an image compression unit 206.

Image data that has been converted into an intermediate language is converted by the DL conversion unit 201 into a display list (hereinafter, referred to as a “DL”) in a data format necessary for interpretation by the downstream interpreter unit 202. The interpreter unit 202 functions as an attribute information generation unit that references all DLs that have been input, performs logical operations on objects such as images and backgrounds, and translates rasterized images and attribute information in block units that are, for example, 32×32 pixels in size. Hereinafter, the images obtained by sectioning an image in block units are referred to as “block images” or “tile images”, and the regions thereof are referred to as “block regions” or “tile regions”. The priority order setting unit 203 determines a degree of importance for each tile image based on the attribute information generated by the interpreter unit 202, and sets a priority order for each tile image indicating the order of transfer to the image compression unit 206. The tile generation unit 204 references the generated priority order, converts the DLs into raster images by re-translating them in block units in order beginning from the DL that is highest in the priority order, and outputs the raster images as tile image data. The packet generation unit 205 generates packets by adding header information to the tile image data, and transfers the packets to the image compression unit 206. The image compression unit 206 performs encoding processing using a predetermined encoding method in order to compress the image data.

Priority Order-Based Encoding Processing

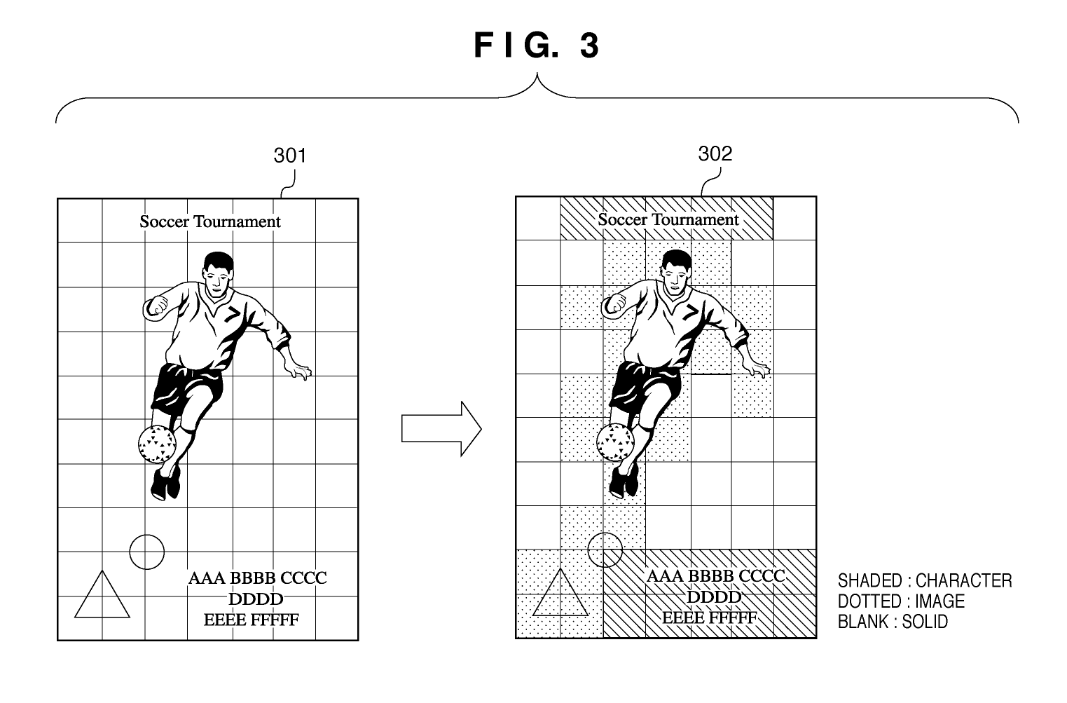

Next is a description of encoding processing performed in accordance with a priority order, with reference to FIG. 3. The image encoding processing unit 110 performs encoding processing on input image data in tile units in order to suppress the memory load and improve image handling. For this reason, as shown by reference numeral 301 in FIG. 3, the input image is divided into tiles of a specified block size.

Next, an attribute such as a character/thin line attribute, a solid image attribute, another image attribute (hereinafter, simply referred to as the “image attribute”) is determined for each tile image, and such attribute information is added to the tile images. As shown by reference numeral 302 in FIG. 3, a shaded region indicates the character attribute, a dotted region indicates the image attribute, and a solid color region indicates a tile image determined to have the solid image attribute. The encoding processing apparatus of the present invention performs control so as to set a priority order for each image attribute of the tile images, and perform encoding processing in order beginning from the tile images that are highest in the priority order. For example, if the priority order is character/thin line>image>solid image, the tile images having the character/thin line attribute are transferred to the image encoding processing unit 110 first. When processing for encoding the tile images having the character/thin line attribute has ended, the tile images having the image attribute are then transferred, and finally the remaining tile images having the solid image attribute are transferred, in accordance with the priority order.

Priority Order-Based Encoding Processing Sequence

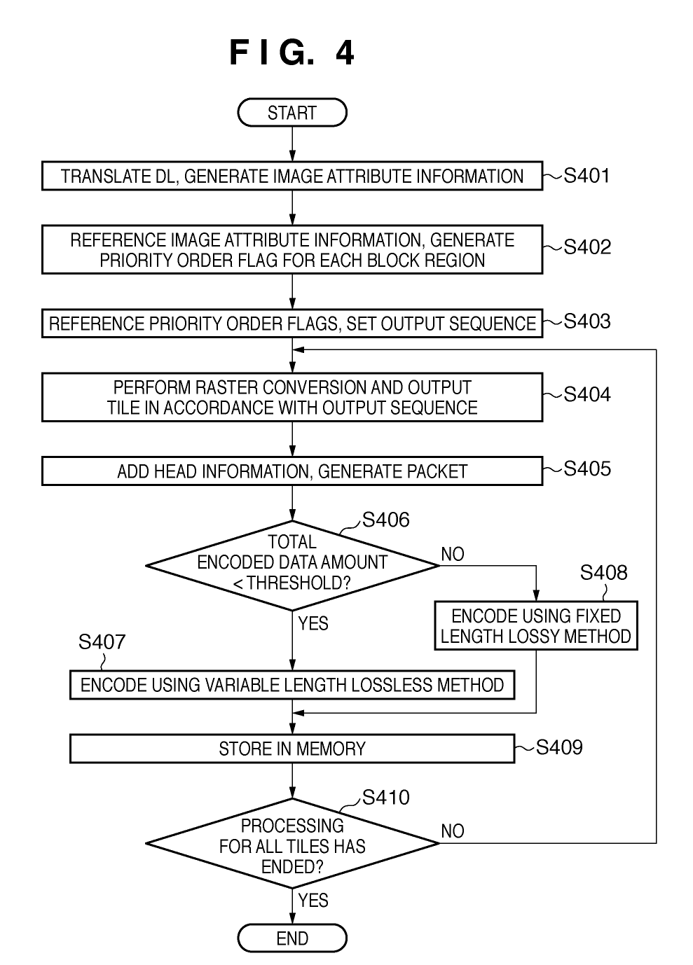

Next is a description of an encoding processing sequence performed in accordance with a priority order according to the present embodiment, with reference to FIG. 4. The processing described below is realized by the CPU 105 loading a program from the ROM 107 or the like, and executing the program. Note that the numbers following “S” in the below description indicate step numbers in the flowcharts.

In S401, upon receiving a print request from the host computer, the CPU 105 inputs input image data to the DL conversion unit 201 via the external I/F 102. The DL conversion unit 201 converts the image data, which is in an intermediate language format, into a display list (hereinafter, referred to as “DL”) format necessary for rendering by the downstream interpreter unit 202. The interpreter unit 202 then translates the DL for each block region, performs logical operations on the objects (background, graphic, pattern, or the like), and calculates pixel values in each block region.

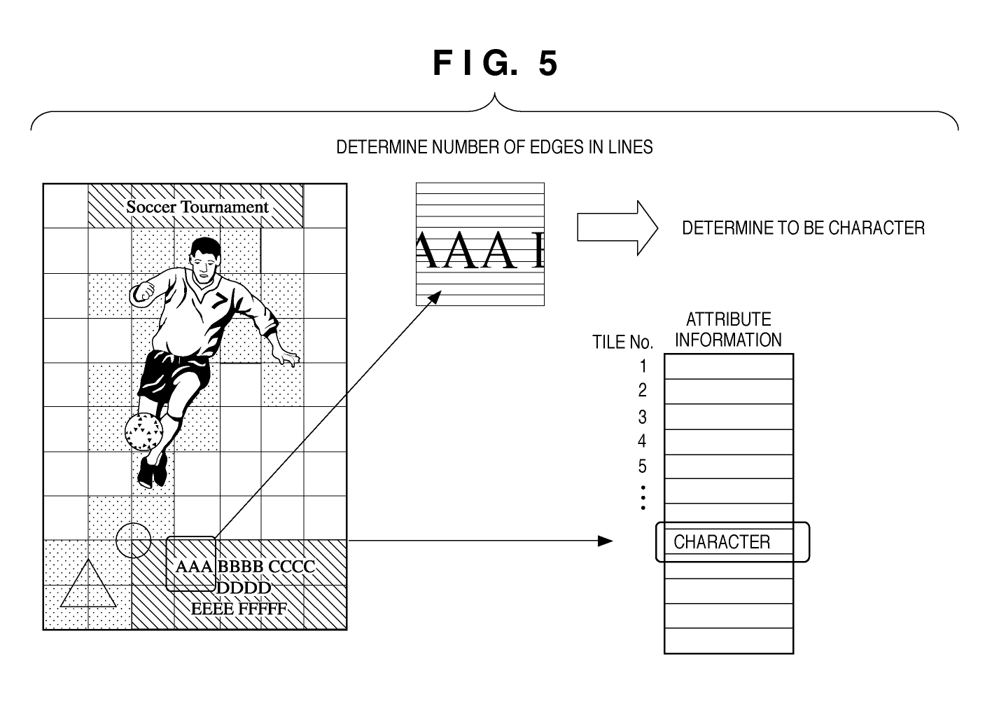

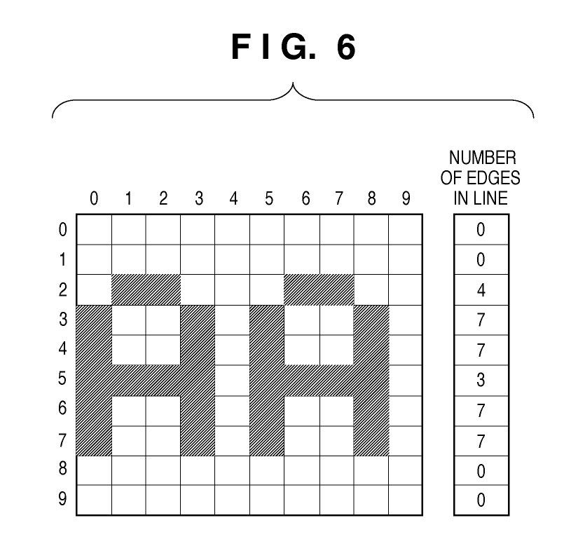

The following describes a method for determining image attribute information with reference to FIGS. 5 and 6. As shown in FIG. 5, the pixels in each tile image region are referenced, the number of edges in each line is calculated, and the character/thin line attribute, the solid image attribute, or the other image attribute is determined based on the total number of edges in the lines. FIG. 6 shows an edge counting method. For the sake of simplification, the following describes a 10×10 pixel block image that, as shown in FIG. 6, has 0, 0, 4, 7, 7 3, 7, 7, 0, and 0 edges in lines 0 to 9 respectively, and the total number of edges in the lines is 35. The term “edge” as referred to here indicates an edge in an image. Accordingly, in the second line, an edge exists between the 0th pixel and the 1st pixel, between the 2nd pixel and the 3rd pixel, between the 5th pixel and the 6th pixel, and between the 7th pixel and the 8th pixel, and thus there are four edges. Assuming that the solid image attribute is determined if the total number of edges is in the range of 0 to 5, the image attribute is determined if it is in the range of 6 to 20, and the character attribute is determined if it is 21 or more, the block image (tile image) shown in FIG. 6 is determined to have the character attribute since the total number of edges is 35. The determined image attribute information is then converted into a list for each tile image. S401 includes the above processing up to and including determining an attribute for each tile image.

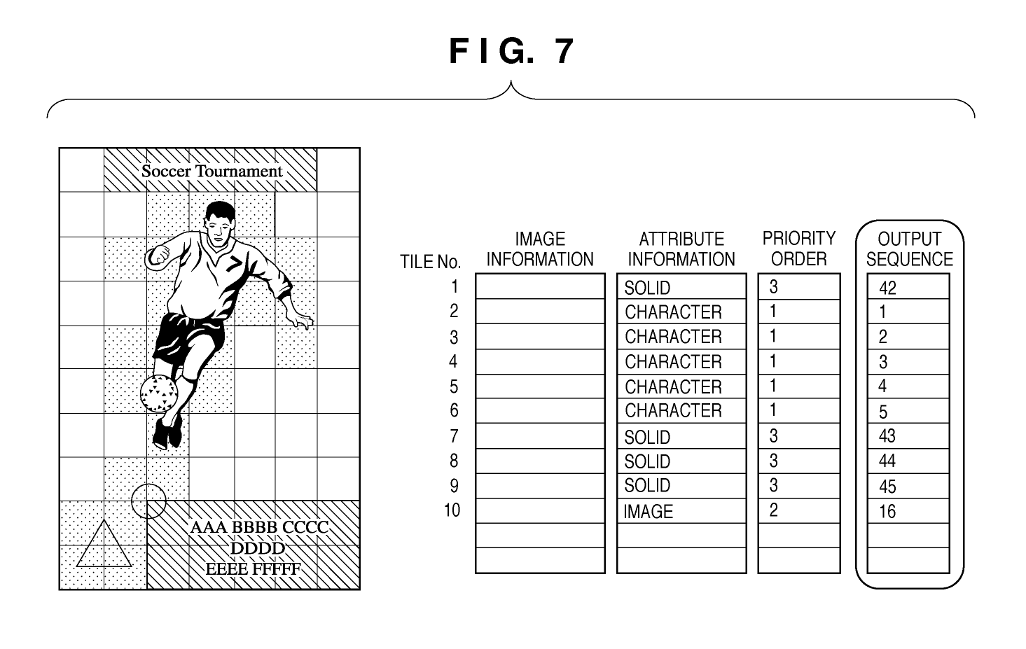

In S402, the priority order setting unit 203 references the image attribute information list, and determines a priority order according to which encoding processing is to be performed. Next is a description of a method for setting the priority order with reference to FIG. 7. The following description takes the example of a priority order including three levels, namely “character”, “image”, and “solid”, in descending order of priority. A priority order flag for each image attribute has the value of 1 for “character”, 2 for “image”, and 3 for “solid”, in descending order of priority. As shown in FIG. 7, in the case where the image attribute information list includes “solid”, “character”, “character”, “character”, . . . , the priority order flags are set to 3, 1, 1, 1, . . . respectively.

Next, in S403, the image encoding processing unit 110 references the set priority order flags, and sets an output sequence for each tile list. As shown in FIG. 7, firstly, positions in the output sequence are set for the lists whose priority order flags are 1. Specifically, 1, 2, 3, . . . are respectively set as positions in the output sequence for the Tile No. 2, 3, 4, . . . lists whose priority order flags are 1. Next, positions in the output sequence are set for the lists whose priority order flags are 2, and finally those whose priority order flags are 3. Accordingly, 42, 1, 2, 3, 4, 5, 43, 44, 45, 16, . . . is set as the output sequence.

Next, in S404 the tile generation unit 204 converts the tile images into raster images by translating the DLs in accordance with the set output sequence, and outputs the raster images as tile images in block units. Subsequently, in S405 the packet generation unit 205 generates packets by adding to the tile images, as header information, tile image coordinate information, an operation mode for the downstream image compression unit 206, and the like.

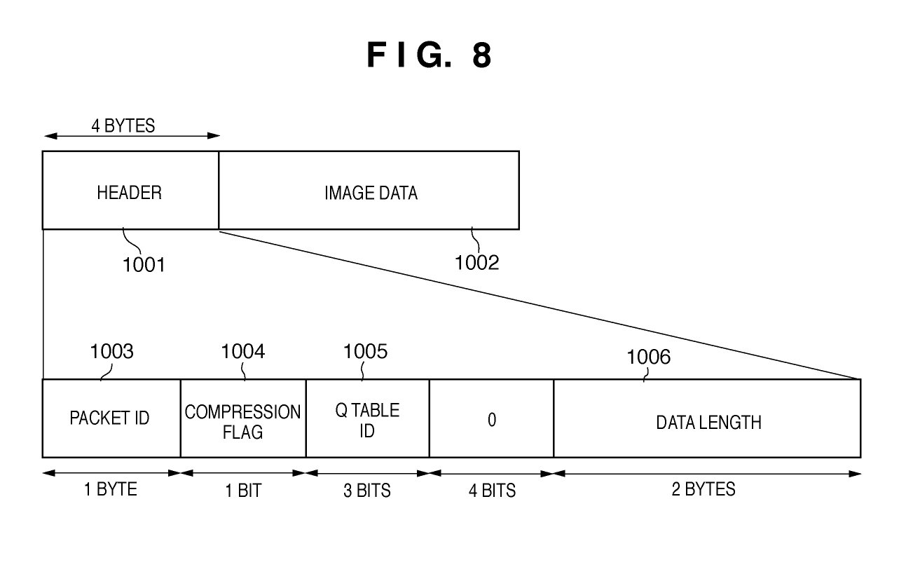

Next is a description of the structure of a packet generated by the packet generation unit 205 with reference to FIG. 8. Each packet is configured by a data body 1002 that stores image data corresponding to one 32×32 pixel tile image, and a header 1001. The header 1001 includes several fields, namely a packet ID 1003, a compression flag 1004, a Q table ID 1005, and a data length 1006. The packet ID 1003 indicates a serial number. The compression flag 1004 indicates whether the image data has been compressed using a variable length lossless method or a fixed length lossy method. The Q table ID 1005 indicates which of various quantization tables having various compression rates was referenced when performing compression. The image data length 1006 indicates the amount of image data stored in the data body 1002. In the present embodiment, the packet ID 1003 is 1 byte, the compression flag 1004 is 1 bit, the Q table ID 1005 is 3 bits, and the image data length 1006 is 2 bytes. Furthermore, as shown in FIG. 8, the header 1001 is provided with a 4-bit field in which the value is set to 0.

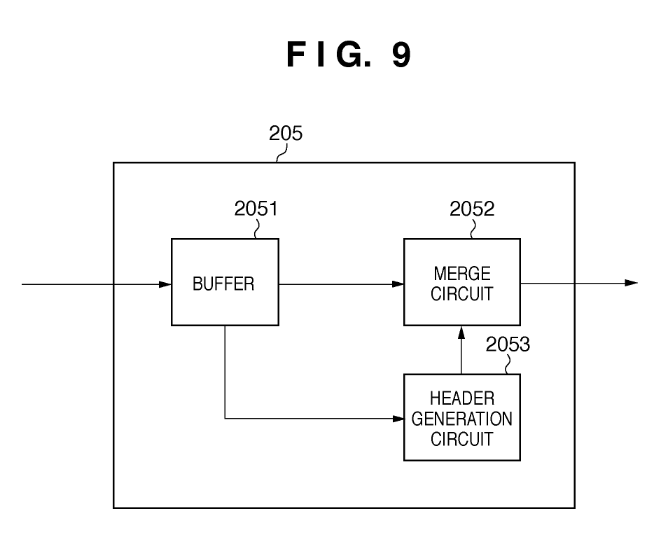

Next is a detailed description of the packet generation unit 205 with reference to FIG. 9. The packet generation unit 205 includes a buffer 2051, a merge circuit 2052, and a header generation circuit 2053. Firstly, the image data generated by the tile generation unit 204 is stored in the buffer 2051 in tile units. The header generation circuit 2053 increments the packet ID 1003 in order, sets the Q table ID 1005 to an ID indicating the quantization table corresponding to the compression rate, and sets the data amount in the image data length 1006. The generated header information is output to the merge circuit 2052. The merge circuit 2052 reads out the image data stored in the buffer 2051 and merges the image data with the header information, thus generating a packet having the format shown in FIG. 8.

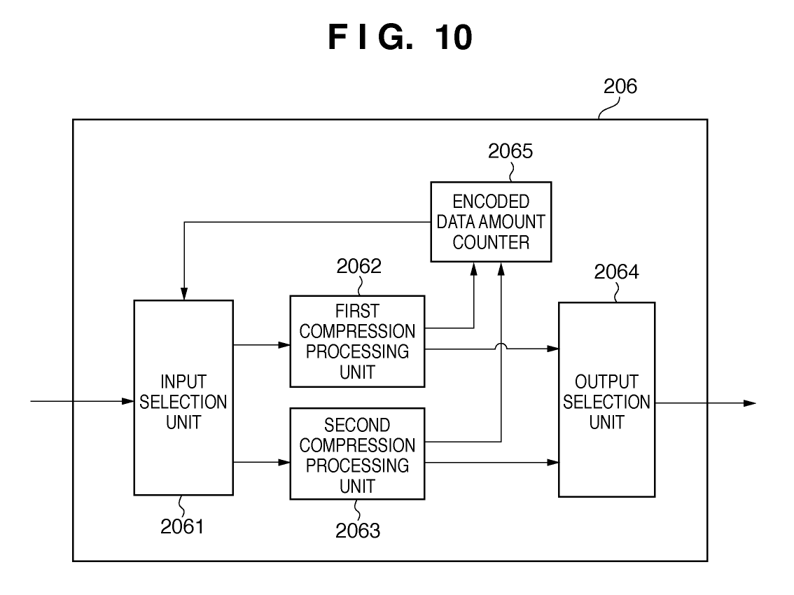

When the packet has been generated, in S406 the image encoding processing unit 110 determines whether the total encoded data amount is less than a pre-set threshold. The total encoded data amount indicates the total of the encoded data amounts of the blocks that have been encoded up to the current time in the execution of block-by-block encoding. The encoded data amount indicates the data amount required to decode the encoded image data. Next is a detailed description of the image compression unit 206 with reference to FIG. 10. The image compression unit 206 includes an input selection unit 2061, a first compression processing unit 2062, a second compression processing unit 2063, an output selection unit 2064, and an encoded data amount counter 2065.

Firstly, the packet data input to the image compression unit 206 is input to the input selection unit 2061. The input selection unit 2061 references the total encoded data amount supplied from the encoded data amount counter 2065, and compares the total encoded data amount with a predetermined threshold. In other words, the encoded data amount counter 2065 functions as an encoded data amount calculation unit that calculates the total encoded data amount of blocks that have been encoded up to the current time. If the total encoded data amount is less than the threshold, the input selection unit 2061 moves to the processing of S407, and supplies the packet data to the first compression processing unit 2062. However, if otherwise, the input selection unit 2061 moves to the processing of S408, and supplies the packet data to the second compression processing unit 2063.

Note that according to the present embodiment, the first compression processing unit 2062 executes encoding processing using a variable length lossless method, and the second compression processing unit 2063 executes encoding processing using a fixed length lossy method. However, the present invention is not limited to these encoding methods, and various types of encoding methods may be employed in the first compression processing unit 2062 and the second compression processing unit 2063. For example, a variable length encoding method may be employed in both the first compression processing unit 2062 and the second compression processing unit 2063. Specifically, the first compression processing unit 2062 may employ, for example, JPEG, which uses a variable length lossy method, or JPEG2000, which can use both a variable length lossy method and a variable length lossless method. Also, the second compression processing unit 2063 may employ, for example, JPEG-LS, GIF, or PNG, which are variable length lossless methods. In the present invention, it is intended for the first compression processing unit 2062 to employ an encoding method preferable for natural images, and for the second compression processing unit 2063 to use an encoding method preferable for graphic images.

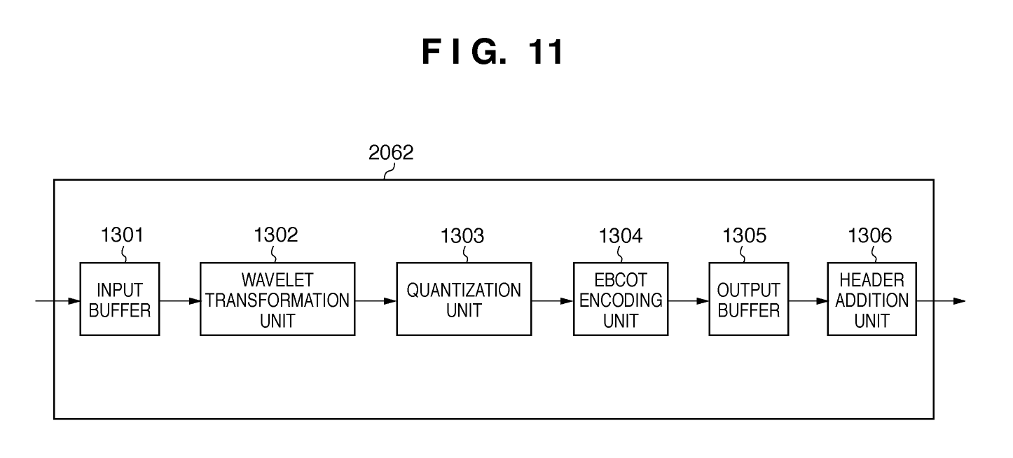

In S407, the first compression processing unit 2062 functions as a first encoding unit and executes encoding processing with use of a variable length lossless method. The following is a description of an example of the configuration of the first compression processing unit 2062 and compression processing using a variable length lossless method with reference to FIG. 11. The first compression processing unit 2062 includes an input buffer 1301, a wavelet transformation unit 1302, a quantization unit 1303, an EBCOT encoding unit 1304, an output buffer 1305, and a header addition unit 1306.

The input buffer 1301 is a data buffer for storing input image data, and upon receiving a predetermined amount of data, the input buffer 1301 outputs the data in accordance with a predetermined sequence to the wavelet transformation unit 1302 connected thereto on the downstream side. Upon receiving the input of the image data from the input buffer 1301, the wavelet transformation unit 1302 performs wavelet transformation, thus converting the image data into derivative component data for subband wavelet coefficients. The quantization unit 1303 performs quantization on the transformed data output by the wavelet transformation unit 1302 with use of a predetermined quantization value. The EBCOT encoding unit 1304 performs predetermined encoding processing on the data output from the quantization unit 1303, thus generating encoded data. When the input of the encoded data from the EBCOT encoding unit 1304 has ended, the output buffer 1305 outputs the encoded data amount, and also notifies the header addition unit 1306 that the encoded data can be output. Thereafter, the output buffer 1305 outputs the encoded data in accordance with a request from the header addition unit 1306. The header addition unit 1306 receives the encoded data and the encoded data amount, and adds header information. Also, the header addition unit 1306 sets the compression flag 1004 shown in FIG. 8 to 0, which indicates that compression was performed using a variable length lossless method, and sets the received encoded data amount in the image data length 1006. The encoded data having the header added thereto is then transmitted to the output selection unit 2064 as packet data. At this time, the output selection unit 2064 performs selection such that the data output from the first compression processing unit 2062 is output from the image compression unit 206.

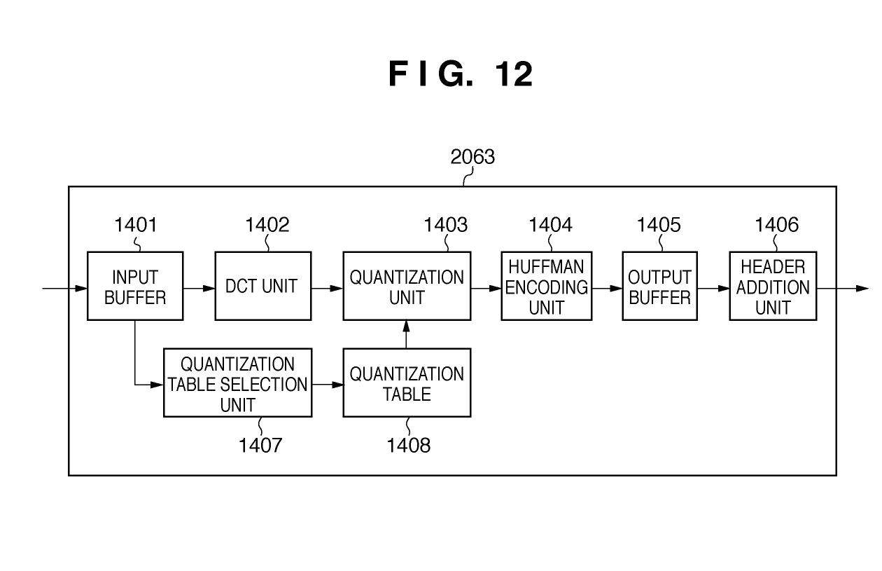

On the other hand, if the total encoded data amount has been determined in S406 to be greater than or equal to the threshold, in S408 the second compression processing unit 2063 functions as a second encoding unit and performs encoding processing using a fixed length lossy method. The following is a description of an example of the configuration of the second compression processing unit 2063 and compression processing using a fixed length lossy method with reference to FIG. 12. The second compression processing unit 2063 includes an input buffer 1401, a DCT unit 1402, a quantization unit 1403, a Huffman encoding unit 1404, an output buffer 1405, a header addition unit 1406, a quantization table selection unit 1407, and a quantization table 1408.

The input buffer 1401 is a data buffer for storing input image data, and upon receiving a predetermined amount of data, the input buffer 1401 outputs the data in accordance with a predetermined sequence to the DCT unit 1402 connected thereto on the downstream side. Upon receiving the input of the image data from the input buffer 1401, the DCT unit 1402 performs discrete cosine transformation, thus converting the image data into frequency component data. The quantization unit 1403 performs quantization on the transformed data output from the DCT unit 1402 with use of a predetermined quantization value. Note that the value used in quantization is input from the quantization table selection unit 1407. The quantization table used in quantization is determined by the quantization table selection unit 1407 with reference to the Q table ID 1005 of the header information stored in the input buffer 1401.

The Huffman encoding unit 1404 performs predetermined encoding processing on the data output from the quantization unit 1403, thus generating encoded data. When the input of the encoded data from the Huffman encoding unit 1404 has ended, the output buffer 1405 outputs the encoded data amount, and also notifies the header addition unit 1406 that the encoded data can be output. Thereafter, the output buffer 1405 outputs the encoded data in accordance with a request from the header addition unit 1406. The header addition unit 1406 receives the encoded data and the encoded data amount, and adds header information. The header addition unit 1406 sets the compression flag 1004 shown in FIG. 8 to 1, which indicates that compression was performed using a fixed length lossy method, and sets the received encoded data amount in the image data length 1006. The encoded data having the header added thereto is then transmitted to the output selection unit 2064 as packet data. At this time, the output selection unit 2064 performs selection such that the data output from the second compression processing unit 2063 is output from the image compression unit 206.

After the encoding processing of S407 or S408 has been performed, in S409 the image encoding processing unit 110 stores the encoded image data in a memory. The packets configuring the compressed image data are sequentially stored in a pre-allocated region in the memory 208 in accordance with the order of the packet IDs 1003 in the headers 1001. Next, in S410 the image encoding processing unit 110 determines whether the storage of all of the tile images in the memory 208 has ended. If processing for all of the tile images has ended, the series of processing related to image processing ends. However, if processing for all of the tile images has not yet ended, the procedure returns to S404, and processing is repeated on any remaining tile images.

As described above, among block images obtained by dividing an image into blocks (tiles), the image processing apparatus according to the present embodiment executes encoding processing using a first method with priority on important block images such as those including thin lines or characters. Furthermore, the image processing apparatus executes encoding processing using a second method if the encoded data amount of blocks that have been encoded becomes greater than or equal to a predetermined threshold. In this way, according to the present embodiment, even if compression is switched mid-processing to a fixed length encoding method (the second method), there is a high possibility that processing for important block images has already ended. As a result, it is possible to suppress the encoded data amount to a predetermined memory amount without significantly influencing image quality as in conventional technology.

### Embodiment 2

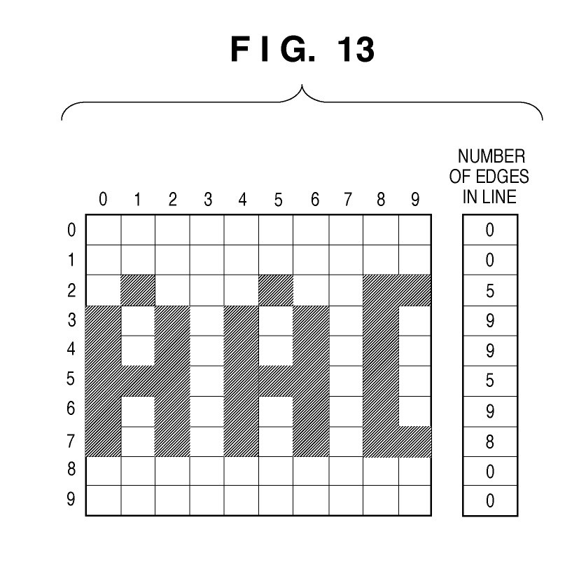

Next is a description of Embodiment 2 with reference to FIGS. 13 to 15. A feature of the present embodiment is that if the target of compression is an image having a high amount of change in image pixel values, such as when a large number of characters exist in tile images, the compression rate is raised in order to compress the image so as to fall within a target memory capacity. Note that the following description focuses mainly on aspects of the configuration and technology that are different from Embodiment 1. In the present embodiment, the interpreter unit 202 creates a Q table ID list that is used for selecting the quantization table to be used by the image compression unit 206.

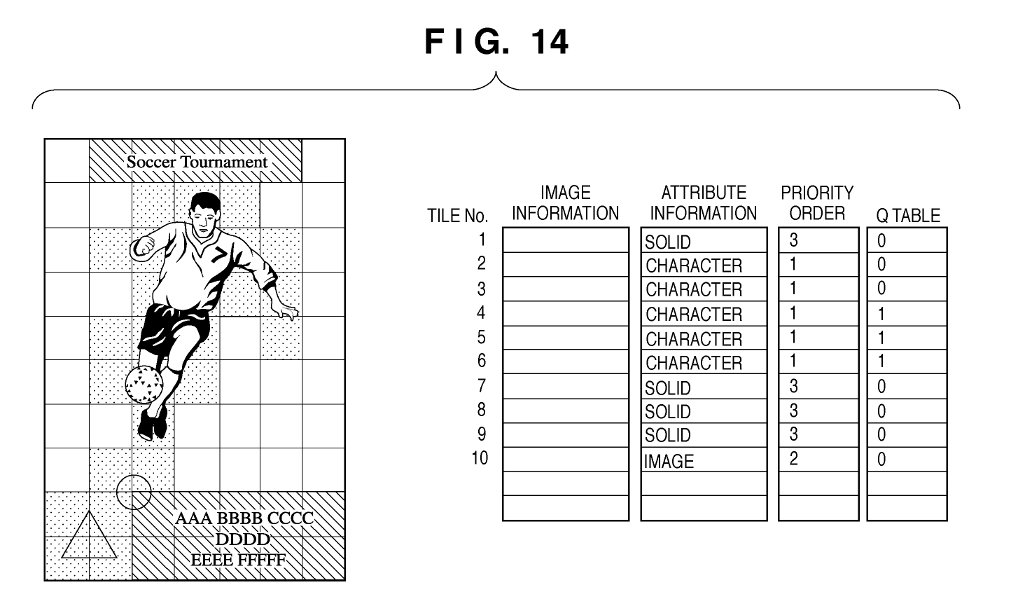

First is a description of an example of a tile image to which the processing of the present embodiment is applied with reference to FIG. 13. The tile image shown in FIG. 13 has 0, 0, 5, 9, 9, 5, 9, 8, 0, and 0 edges in lines 0 to 9 respectively, and the total number of edges in the lines is 45. Likewise to Embodiment 1, the solid image attribute is determined if the total number of edges is in the range of 0 to 5, the image attribute is determined if it is in the range of 6 to 20, and the character attribute is determined if it is 21 or more. The tile image shown in FIG. 13 is therefore determined to have the character attribute. Furthermore, in the present embodiment, if the total number of edges is 40 or more, a determination is made that the amount of change in image pixel values is high, and a value of 1 is set in the Q table ID list, which indicates that a quantization table for performing compression with a high compression rate is to be used. FIG. 14 shows a Q table ID list according to the present embodiment. As shown in FIG. 14, in the case of, for example, using two quantization tables having different compression rates, a value of 1 is set in the Q table ID list when quantization is to be performed with a high compression rate, and a value of 0 is set when another default compression rate is sufficient.

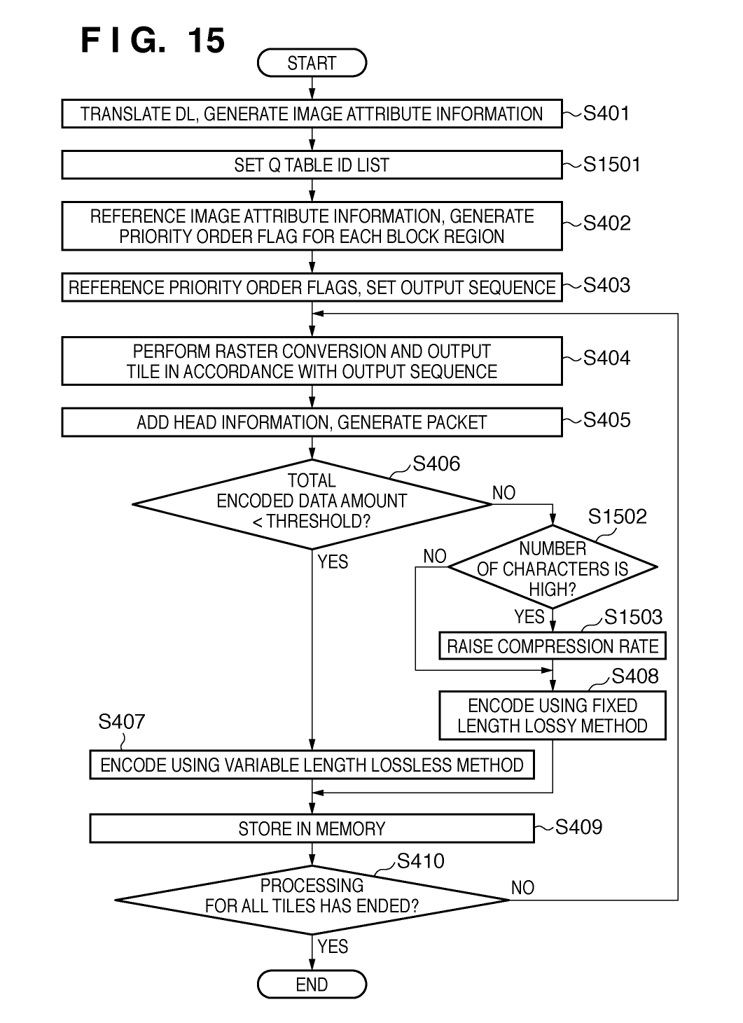

Next is a description of an encoding processing sequence of the present embodiment with reference to FIG. 15. Here, processing that is the same as that of Embodiment 1 shown in FIG. 4 has been given the same step numbers, and a description thereof has been omitted. In S1501, when counting the number of edges in each line, the interpreter unit 202 determines whether the total number of edges is greater than or equal to a predetermined value (here, greater than or equal to 40), and sets a value in the Q table ID list. In other words, the interpreter unit 202 determines whether the pixel change amount is high, and determines a compression rate for each tile image. Specifically, the interpreter unit 202 counts, with use of the CPU 105, the total number of edges in the tile image data that has been expanded in the work memory, determines the number of characters to be high if the total is greater than or equal to a predetermined value, and determines the number of characters to be low if the total is less than the predetermined value. If the number of characters is high, the interpreter unit 202 sets a value of 1 in the Q table ID list as described above, and otherwise sets a value of 0.

Also, according to the present embodiment, if the total encoded data amount is greater than or equal to the threshold value, in S1502 the second compression processing unit 2063 references the Q table ID list and determines whether the number of characters is high in each of the tile images. If a value of 1 is set in the Q table ID list, the procedure proceeds to S1503, and if a value of 0 is set, the procedure proceeds to S408. Specifically, the quantization table selection unit 1407 of the second compression processing unit 2063 references the Q table ID 1005 in the header information of the image data stored in the input buffer 1401. If the value of the Q table ID 1005 is 0, the quantization table selection unit 1407 references the quantization table set to a default compression rate in the quantization table 1408. If the value of the Q table ID 1005 is 1, the quantization table selection unit 1407 references another quantization table having a higher compression rate. Thereafter, in S408 the second compression processing unit 2063 executes fixed length lossy encoding processing with use of the compression rate referenced by the quantization table selection unit 1407. In this way, switching the quantization table that is referenced with use of the Q table ID 1005 enables switching the compression rate used in compression processing in tile units.

As described above, in addition to the control according to Embodiment 1, the image processing apparatus of the present embodiment switches to a high compression rate if the number of characters (total number of edges) is high, and executes encoding processing using the high compression rate. Accordingly, even if an image includes blocks having different numbers of characters, control can be performed so as to cause the encoded data amount to fall within a target encoded data amount.

### Embodiment 3

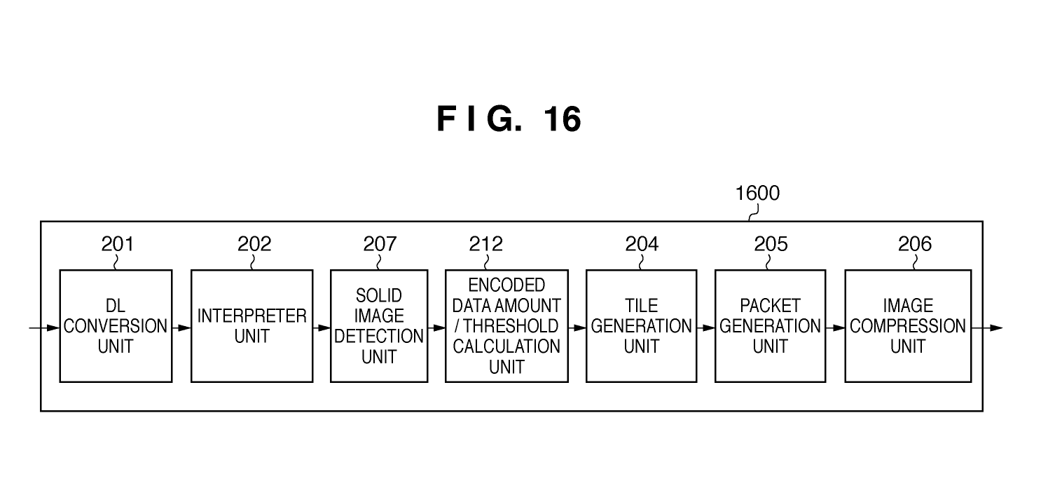

Below is a description of Embodiment 3 with reference to FIGS. 16 to 18. When encoding image data, the same encoding processing is generally performed without giving consideration to image attributes. For this reason, the encoded data amount allocated in a memory region is currently the same for unimportant tile images and important tile images. In view of this, reducing the encoded data amount of the unimportant tile images and allocating the thus saved amount to the encoded data amount of important tile images enables efficient utilization of memory capacity and enables performing control so as to improve image quality. In Embodiment 1, the encoded data amount is adjusted by generating image attribute information and setting a priority order for each tile image. However, since a threshold is set is advance in this method, there are cases where the memory region cannot be fully utilized.

As one example, assume the case of an image whose tile images are 20% solid images and 80% character images. When there are few solid images and many character images in this way, there are cases where an excessively large memory region is allocated for a fixed length lossy method. This is caused by the fact that the total encoded data amount in a fixed length lossy method is low if there are few solid images, and therefore the pre-set fixed length region in the memory is excessively large. In this case, if the excess memory region for the fixed length lossy method can be allocated to the memory region for a variable length lossless method, the memory can be utilized more effectively, and control can be performed so as to improve the image quality. In view of this, in the present embodiment, first the sum total encoded data amount when using a fixed length method on unimportant block images is estimated with use of image attribute information, and a predetermined threshold for the memory region for a variable length lossless method is changed according to the amount of excess memory region. This enables allocating a higher encoded data amount for the compression of the important blocks using the variable length lossless method.

Next is a description of an example of the configuration of an image encoding processing unit 1600 according to the present embodiment with reference to FIG. 16. The image encoding processing unit 1600 has basically the same configuration as that of the image encoding processing unit 110, with the exception of further including a solid image detection unit 207 and an encoded data amount/threshold calculation unit 212. For each block, the solid image detection unit 207 detects whether the block is a block image for which the fixed length lossy method is sufficient (assumed here to be a solid image) based on the attribute information generated by the interpreter unit 202, and generates a solid image detection flag. Specifically, the solid image detection unit 207 detects a block whose total number of edges is less than or equal to a predetermined value (e.g., less than or equal to 5) to be a block image for which the fixed length lossy method is sufficient. The encoded data amount/threshold calculation unit 212 references the solid image detection flags generated by the solid image detection unit 207, and estimates a sum total encoded data amount for the case of encoding the solid images with the fixed length lossy method. The encoded data amount/threshold calculation unit 207 then calculates a remaining amount of memory region based on the sum total encoded data amount and the total memory region, and changes the predetermined threshold used when determining whether to perform encoding with use of the variable length lossless method. The other processing units are similar to those in Embodiment 1, and therefore descriptions thereof have been omitted.

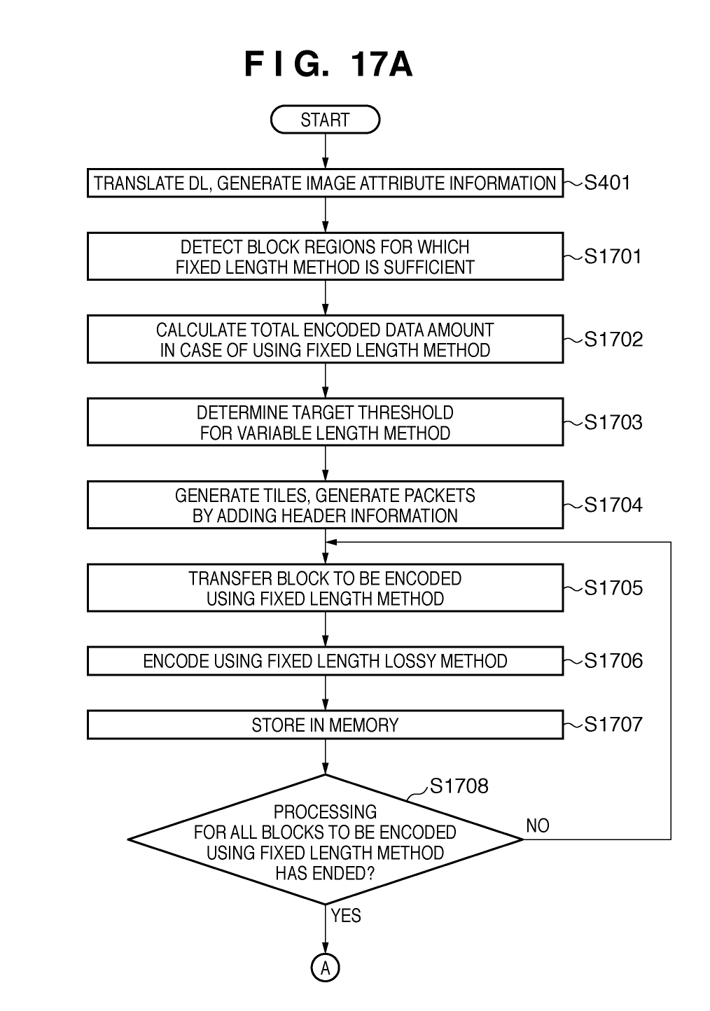

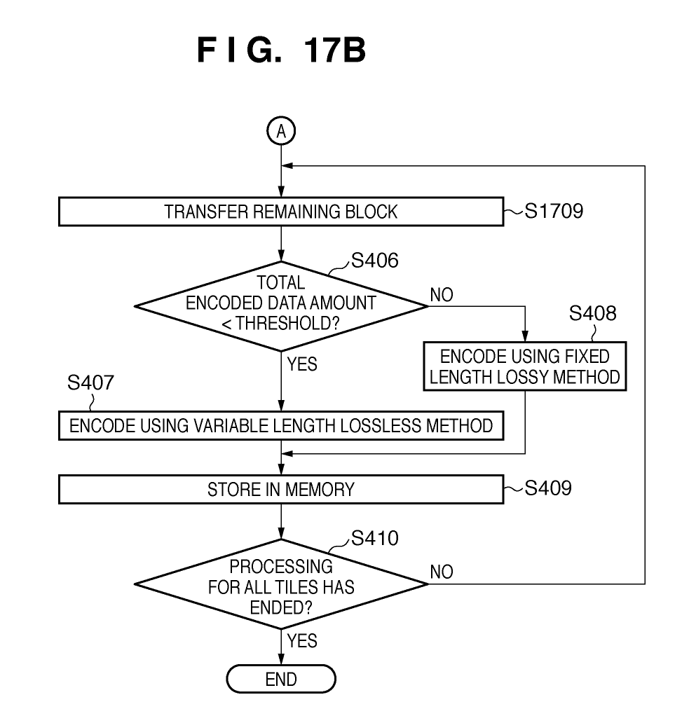

Next is a description of an encoding processing sequence of the present embodiment with reference to FIGS. 17A and 17B. The processing described below is realized by the CPU 105 loading a program from the ROM 107 or the like, and executing the program. Note that the numbers following “S” in the below description indicate step numbers in the flowcharts. Also, processing that is the same as that of the flowchart shown in FIG. 4 has been given the same step numbers, and a description thereof has been omitted.

After image attribute information has been generated in S401, in S1701 the solid image detection unit 207 references the image attribute information list (indicating “character/thin line”, “image”, “solid”, or the like) and detects block images for which the fixed length lossy method is sufficient (here, assumed to be solid images). The solid image detection unit 207 then generates solid image detection flags. The flag value is set to 1 for a tile image detected as being a block image for which a fixed length lossy method is sufficient (a solid image), and otherwise is set to 0. Thereafter, based on the solid image detection flags, the solid image detection unit 207 determines a tile transfer sequence for processing performed on the downstream side of the solid image detection unit 207.

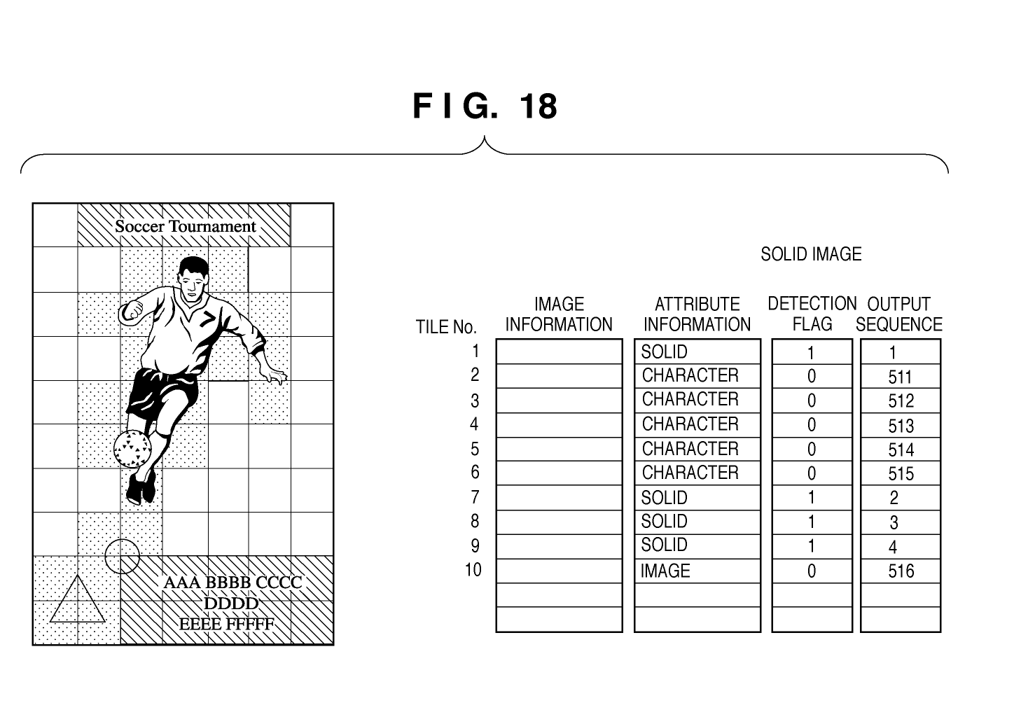

Next is a description of the solid image detection flags with reference to FIG. 18. At the time of execution of the processing in S1701, attribute information has already been generated for each tile image. The solid image detection unit 207 therefore determines the values of the solid image detection flags based on the attribute information. For example, the attribute information of the first tile image indicates “solid”, and therefore the value of the solid image detection flag is set to 1. The attribute information of the second tile image indicates “character”, and therefore the value of the solid image detection flag is set to 0. The remaining solid image detection flags are set in the same way. Although output numbers are not shown in FIG. 18, output numbers are allocated in order beginning from the tile images whose solid image detection flags have a value of 1. This enables the solid images to be transferred to and stored in the memory first.

Next, in S1702 the encoded data amount/threshold calculation unit 212 references the solid image detection flags, and estimates a sum total encoded data amount in the case of compressing the solid images with use of the fixed length lossy method. For example, the encoded data amount of one block compressed with use of the fixed length lossy method is set in advance, the encoded data amount for one tile image is added to the sum total encoded data amount if the value of a solid image detection flag is 1, and addition is not performed if the value of the solid image detection flag is 0. Performing this processing for all of the tile images enables estimating the sum total encoded data amount in the case of using the fixed length lossy method. In S1703, the encoded data amount/threshold calculation unit 212 calculates the remaining memory region based on the encoded data amount estimated in S1702, and based on the remaining memory region, calculates and changes the target threshold for the variable length lossless method to be used in the compression of the remaining block images. In this way, by first estimating the total encoded data amount for the fixed length lossy method and allocating a memory region, it is possible to estimate in advance the encoded data amount for the variable length lossless method that is to be allocated to important tile images. Thereafter a threshold is determined for performing encoding with use of the variable length lossless method, thus enabling the encoded data amount for the variable length lossless method to be higher than that in the case of setting the threshold in advance.

Next, in S1704 the tile generation unit 204 generates tile image data by converting the 32×32 pixel block images into raster images. The packet generation unit 205 then adds tile image coordinate information and the like to the tile images as header information, and generates packets. Subsequently, in S1705 the packet generation unit 205 references the solid image detection flags and transfers a block whose flag has a value of 1 to the image compression unit 206 in accordance with the output numbers.

Next, in S1706 the second compression processing unit 2063 of the image compression unit 206 encodes the transferred block with use of the fixed length lossy method. In S1707, the image compression unit 206 transfers the obtained encoded image data to the memory so as to be stored therein. Regarding the storage of encoded image data in the memory, processing is performed block-by-block, and the encoded image data of each block is transferred to and stored in the memory after the processing thereon has ended. In S1708, the image encoding processing unit 1600 determines whether all of the solid images have been compressed with the fixed length lossy method and stored in the memory. If such processing has not ended for all of the solid images, the procedure returns to S1705, and a remaining block image whose solid image detection flag has a value of 1 is compressed with use of the fixed length lossy method. If such processing has ended for all of the solid images, the procedure proceeds to S1709, in which the image encoding processing unit 1600 starts transferring the block images whose solid image detection flags have a value of 0 (i.e., the block images that are not solid images). Although it is assumed here that the remaining blocks are successively transferred without the provision of a particular priority order, a configuration is possible in which, for example, a priority order is determined, and transfer is performed in accordance with the priority order as in Embodiment 1. Note that a description of the processing from S406 to S410 has been omitted since it is the same as that of the flowchart in FIG. 4.

As described above, the image processing apparatus of the present embodiment first estimates a memory region for when unimportant tile images (solid images or the like) are compressed with use of a fixed length encoding method, and changes a predetermined threshold in accordance with the remaining memory region in order to fully utilize the memory region. This enables increasing the size of the memory region corresponding to the encoded data amount obtained when performing encoding with a variable length encoding method. The present embodiment therefore enables full utilization of the remaining memory region, thus improving image quality. The image processing apparatus of the present embodiment may also be realized by a combination of Embodiments 1 and 2.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-265531 filed on Nov. 20, 2009, which is hereby incorporated by reference herein in its entirety.

What is claimed is:

1. An image processing apparatus comprising:
an input unit that receives an input of image data;
an attribute information generation unit that generates attribute information for each predetermined block unit of the input image data;
a priority order setting unit that, based on the generated attribute information, sets a priority order for encoding in the block units;
an encoded data amount calculation unit that, in encoding of the blocks in order based on the set priority order, calculates a total encoded data amount of blocks that have been encoded;
a first encoding unit that, in a case where the total encoded data amount is less than a predetermined threshold, encodes image data of a block with use of a first method; and
a second encoding unit that, in a case where the total encoded data amount is greater than or equal to the predetermined threshold, encodes image data of the block with use of a second method that results in a lower encoded data amount than the first method.

2. The image processing apparatus according to claim 1,
wherein the attribute information generation unit comprises an edge counting unit that, for each of the block units, calculates a total number of edges where a pixel value changes, and generates, for each of the block units, the attribute information based on the total number of edges calculated by the edge counting unit.

3. The image processing apparatus according to claim 2,
wherein the priority order setting unit sets, to the higher the priority, the priority of a block that has the attribute information indicating the higher the total number of edges.

4. The image processing apparatus according to claim 2,
wherein the second encoding unit encodes image data of a block whose total number of edges is greater than or equal to a predetermined value with use of a compression rate that is higher than a compression rate used to encode image data of a block whose total number of edges is less than the predetermined value.

5. The image processing apparatus according to claim 2,
wherein the first encoding unit executes encoding processing with use of a variable length encoding method as the first method, and
the second encoding unit executes encoding processing with use of a fixed length encoding method as the second method.

6. The image processing apparatus according to claim 5, further comprising:
an estimation unit that estimates a sum total encoded data amount for a case where the second encoding unit encodes image data of blocks whose total number of edges is less than or equal to a predetermined value;
a change unit that changes the predetermined threshold in accordance with the estimated sum total encoded data amount; and
a control unit that causes the second encoding unit to encode the image data of the blocks whose total number of edges is less than or equal to the predetermined value, and in causing image data of remaining blocks to be encoded in order based on the set priority, causes encoded to be performed by the first encoding unit or the second encoding unit based on the changed predetermined value.

7. The image processing apparatus according to claim 2,
wherein the first encoding unit executes encoding processing with use of a lossless encoding method as the first method, and
the second encoding unit executes encoding processing with use of a lossy encoding method as the second method.

8. A control method for an image processing apparatus, comprising:
receiving, by an input unit, an input of image data;
generating, by an attribute information generation unit, attribute information for each predetermined block unit of the input image data;
setting, by a priority order setting unit, a priority order for encoding in the block units, based on the generated attribute information;
in encoding of the blocks in order based on the set priority order, calculating, by an encoded data amount calculation unit, a total encoded data amount of blocks that have been encoded;
in a case where the total encoded data amount is less than a predetermined threshold, encoding, by a first encoding unit, image data of a block with use of a first method; and
in a case where the total encoded data amount is greater than or equal to the predetermined threshold, encoding, by a second encoding unit, image data of the block with use of a second method that results in a lower encoded data amount than the first method.

9. A computer-readable storage medium storing a computer program for causing a computer to execute the control method for an image processing apparatus according to claim 8.
